(19) United States
(12) Patent Application Publication
(10) Pub. No.: US 2023/0291510 A1
(43) Pub. Date: Sep. 14, 2023

(54) METHODS AND ALGORITHMS OF DATA MULTIPLEXING AT PHY LAYER

(71) Applicant: Telefonaktiebolaget LM Ericsson (publ), Stockholm (SE)

(72) Inventors: Bikramjit SINGH, Raasepori (FI); Alexey SHAPIN, Luleå (SE); Yufei BLANKENSHIP, Kildeer, IL (US); Mattias ANDERSSON, Sundbyberg (SE)

(21) Appl. No.: 18/040,346

(22) PCT Filed: Aug. 6, 2021
(86) PCT No.: PCT/EP2021/072110

§ 371 Date: Feb. 2, 2023

Related U.S. Application Data
(60) Provisional application No. 63/063,043, filed on Aug. 7, 2020.

(51) Int. Cl. H04L 1/1867

(52) U.S. Cl. CPC H04L 1/1887; H04L 1/1893

(57) ABSTRACT

A method, system and apparatus for methods and algorithms of data multiplexing at a physical (PHY) layer. A network node is configured to schedule using a single downlink control information, DCI, message a first transmission with repetition of a first transport block, TB, and a second transmission with repetition of a second TB, the repetitions of the first and second TBs being mapped to non-overlapping time-domain resources and the repetitions of first and second TBs being mapped to a same physical resource block, PRB, set; and trigger the first transmission with repetition of the first TB and the second transmission with repetition of the second TB based on the single DCI scheduling. A wireless device, WD, is configured to receive the single DCI message; and process the repetitions of the first TB and the repetitions of the second TB based at least in part on the single DCI scheduling.

### FIELD

The present disclosure relates to wireless communications, and in particular, to methods and algorithms of data multiplexing at a physical (PHY) layer.

### BACKGROUND

In modern wireless technologies, e.g., 3^{rd} Generation Partnership Project (3GPP) standards like Long Term Evolution (LTE) and New Radio (NR, also called 5^{th} Generation or 5G), radio resource allocation/management is done by a network node (NN), such as a base station. In downlink communication link the network node is aware of available data for transmission and can schedule needed amount of resources with very good precision. For uplink communication link the scheduling becomes more challenging, because network node may not know for sure how much data is available for transmission. There are known techniques to inform network node about buffer status, e.g. scheduling request and buffer status report; however, quite many uncertainties exist due to delay of buffer status message and limited precision of signaling.

The network node, e.g., base station, usually allocates time/frequency/spatial/code or other kind of resources either without any information about buffer status in the wireless device or based on estimation of data in WD's buffer. The first case usually happens during initial data exchange between NN and WD, then WD can send buffer status report to inform NN about data available for transmission. Later, WD can periodically send an update about buffer state.

When the NN allocates uplink resources, it sends scheduling command or grant. The grant can be dynamic (sent some time before WD can transmit on granted resources) or static/semi-persistent/configured.

In NR, terminals and network nodes (such as the UE and the gNodeB, respectively) data transmission is controlled by the nodes using grants containing among other things the details in allocated spectrum resource and the modulation and coding to transmit over that resource. The modulation and coding scheme (MCS) is signaled in the downlink control information (DCI). DCI message typically is sent over Physical Downlink Control Channel (PDCCH). An example of this process in DL and UL is shown on FIG. 1.

The modulation and coding scheme (MCS) field is an index pointing to entries to the MCS table in the 3GPP specification, which once combined together with the resource allocation, will result in the transport block size (TBS) that will be transmitted. In the legacy, the reason for a range of value for MCS is that the WD ability to reliably receive or transmit depends on its location in the cell. A WD near the network node has a low path loss and can be scheduled with a high order modulation which a WD in the cell edge faces both high path loss and intercell interference, so that the transmission is to be coded with a stronger code rate and transmitted with a lower order modulation.

In the 3GPP Release 16 (Rel-16) enhanced ultra-reliable low latency communication (eURLLC) study item and working item (WI) considered intra-WD multiplexing. In scenarios when one radio link to/from WD carries multiple traffic types, those traffic flows can have different latency and/or reliability requirements. For being spectrally efficient, the scheduler (e.g., in network node) should ensure different reliability level through right resource allocation strategy and appropriate MCS. Moreover, collisions may happen between dynamically and semi-persistently scheduled data transmissions. As it was considered in 3GPP Rel-16 eURLLC, in case of overlapping in time only prioritization procedure is possible, meaning that a low priority transport block (TB) may be discarded, and only high priority transport blocks may be transmitted/received.

### SUMMARY

Some embodiments advantageously provide methods, systems, and apparatuses for methods and algorithms of data multiplexing at a physical (PHY) layer.

In one embodiment, a network node is configured to schedule a transmission comprising a plurality of transport blocks (TBs); and receive and/or transmit the transmission comprising the plurality of TBs based on the scheduling.

In one embodiment, a wireless device (WD) is configured to receive signaling, the signaling scheduling a transmission comprising a plurality of transport blocks (TBs); and receive and/or transmit the transmission comprising the plurality of TBs based on the scheduling.

According to an aspect of the present disclosure, a method implemented in a network node configured to communicate with a wireless device, WD, is provided. The method includes scheduling using a single downlink control information, DCI, message a first transmission with repetition of a first transport block, TB, and a second transmission with repetition of a second TB, the repetitions of the first and second TBs being mapped to non-overlapping time-domain resources and the repetitions of first and second TBs being mapped to a same physical resource block, PRB, set; and triggering the first transmission with repetition of the first TB and the second transmission with repetition of the second TB based on the single DCI scheduling.

In some embodiments of this aspect, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments of this aspect, the first transmission with repetition comprises a mini-slot repetition of the first TB and the second transmission with repetition comprises a mini-slot repetition of the second TB. In some embodiments of this aspect, the first transmission with repetition comprises a slot-based repetition of the first TB and the second transmission with repetition comprises a slot-based repetition of the second TB.

In some embodiments of this aspect, the first transmission with repetition comprises a mini-slot repetition of the first TB and the second transmission with repetition comprises a slot-based repetition of the second TB. In some embodiments of this aspect, the repetitions of at least one of the first TB and the repetitions of the second TB are time-domain consecutive. In some embodiments of this aspect, the repetitions of at least one of the first TB and the second TB are separated by a pre-configured time-domain gap. In some embodiments of this aspect, the first transmission comprises a first number of repetitions of the first TB and the second transmission comprises a second number of repetitions of the second TB, the first number being different than the second number.

In some embodiments of this aspect, the scheduling in the single DCI message comprises scheduling a physical uplink shared channel, PUSCH, in the single DCI, the scheduled PUSCH comprising the repetitions of the first and second TBs. In some embodiments of this aspect, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission.

In some embodiments of this aspect, the first TB and the second TB are scheduled for transmission by the network node. In some embodiments of this aspect, the first TB and the second TB are scheduled for transmission by the wireless device. In some embodiments of this aspect, a repetition of at least one of the first and second TB is skipped.

According to another aspect, a method implemented in a wireless device, WD, configured to communicate with a network node is provided. The method comprises receiving a single downlink control information, DCI, message scheduling a first transmission with repetition of a first transport block, TB, and a second transmission with repetition of a second TB, the repetitions of the first and second TBs being mapped to non-overlapping time-domain resources and the repetitions of first and second TBs being mapped to a same physical resource block, PRB, set; and processing the repetitions of the first TB and the repetitions of the second TB based at least in part on the single DCI scheduling.

In some embodiments of this aspect, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments of this aspect, the first transmission with repetition comprises a mini-slot repetition of the first TB and the second transmission with repetition comprises a mini-slot repetition of the second TB. In some embodiments of this aspect, the first transmission with repetition comprises a slot-based repetition of the first TB and the second transmission with repetition comprises a slot-based repetition of the second TB.

In some embodiments of this aspect, the first transmission with repetition comprises a mini-slot repetition of the first TB and the second transmission with repetition comprises a slot-based repetition of the second TB. In some embodiments of this aspect, the repetitions of at least one of the first TB and the repetitions of the second TB are time-domain consecutive. In some embodiments of this aspect, the repetitions of at least one of the first TB and the second TB are separated by a pre-configured time-domain gap. In some embodiments of this aspect, the first transmission comprises a first number of repetitions of the first TB and the second transmission comprises a second number of repetitions of the second TB, the first number being different than the second number.

In some embodiments of this aspect, the scheduling in the single DCI message comprises scheduling a physical uplink shared channel, PUSCH, in the single DCI, the scheduled PUSCH comprising the repetitions of the first and second TBs. In some embodiments of this aspect, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission.

In some embodiments of this aspect, the first TB and the second TB are scheduled for transmission by the network node. In some embodiments of this aspect, the first TB and the second TB are scheduled for transmission by the wireless device. In some embodiments of this aspect, a repetition of at least one of the first and second TB is skipped.

According to yet another aspect, a method implemented in a network node configured to communicate with a wireless device, WD, is provided. The method includes scheduling using a single downlink control information, DCI, message a first transmission of a first transport block, TB, and a second transmission of a second TB, the first TB being mapped to a first subset of a physical resource block, PRB, set and the second TB being mapped to a second subset of the PRB set, the first subset corresponding to different frequency resources than the second subset; and triggering the first transmission of the first TB and the second transmission of the second TB based on the single DCI scheduling.

In some embodiments of this aspect, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments of this aspect, the first and second TBs are mapped to non-overlapping time-domain resources. In some embodiments of this aspect, the first and second TBs are mapped to overlapping time-domain resources. In some embodiments of this aspect, the first transmission is with repetition of the first TB and the second transmission is with repetition of the second TB.

In some embodiments of this aspect, the first transmission is without repetition of the first TB and the second transmission is with repetition of the second TB. In some embodiments of this aspect, at least one of: a first number of PRBs corresponding to the first transmission of the first TB is different from a second number of PRBs corresponding to the second transmission of the second TB; and a first number of orthogonal frequency division multiplexing, OFDM, symbols corresponding to the first transmission of the first TB is different from a second number of OFDM symbols corresponding to the second transmission of the second TB. In some embodiments of this aspect, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission. In some embodiments of this aspect, the first TB and the second TB are scheduled for transmission by the network node. In some embodiments of this aspect, the first TB and the second TB are scheduled for transmission by the wireless device.

According to another aspect, a method implemented in a wireless device, WD, configured to communicate with a network node is provided. The method includes receiving a single downlink control information, DCI, message scheduling a first transmission of a first transport block, TB, and a second transmission of a second TB, the first TB being mapped to a first subset of a physical resource block, PRB, set and the second TB being mapped to a second subset of the PRB set, the first subset corresponding to different frequency resources than the second subset; and processing the first transmission of the first TB and the second transmission of the second TB based on the single DCI scheduling.

In some embodiments of this aspect, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments of this aspect, the first and second TBs are mapped to non-overlapping time-domain resources. In some embodiments of this aspect, the first and second TBs are mapped to overlapping time-domain resources. In some embodiments of this aspect, the first transmission is with repetition of the first TB and the second transmission is with repetition of the second TB. In some embodiments of this aspect, the first transmission is without repetition of the first TB and the second transmission is with repetition of the second TB.

In some embodiments of this aspect, at least one of: a first number of PRBs corresponding to the first transmission of the first TB is different from a second number of PRBs corresponding to the second transmission of the second TB; and a first number of orthogonal frequency division multiplexing, OFDM, symbols corresponding to the first transmission of the first TB is different from a second number of OFDM symbols corresponding to the second transmission of the second TB. In some embodiments of this aspect, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission.

According to another aspect of the present disclosure, a network node is provided. The network node includes processing circuitry. The processing circuitry is configured to cause the network node to perform any one of more of the methods above.

According to another aspect of the present disclosure, a wireless device, WD, is provided that includes processing circuitry. The processing circuitry is configured to cause the WD to perform any one of more of the methods above.

According to yet another aspect, a computer readable medium comprising computer instructions executable by the processing circuitry to perform any one of more of the methods above is provided.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example downlink (DL) and uplink (UL) resource allocation;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node according to some embodiments of the present disclosure;

FIG. 9 is a flowchart of an example process in a wireless device according to some embodiments of the present disclosure;

FIG. 10 is a flowchart of an example process in a network node according to some embodiments of the present disclosure;

FIG. 11 is a flowchart of an example process in a wireless device according to some embodiments of the present disclosure;

FIG. 12 is a flowchart of an example process in a network node according to some embodiments of the present disclosure;

FIG. 13 is a flowchart of an example process in a wireless device according to some embodiments of the present disclosure;

FIG. 14 illustrates an example of single PHY layer transmission with multiple transport blocks according to some embodiments of the present disclosure;

FIG. 15 illustrates an example of a single DCI scheduling two TBs according to some embodiments of the present disclosure;

FIG. 16 illustrates an example FDM arrangement according to some embodiments of the present disclosure;

FIG. 17 illustrates an example TDM arrangement where the two TBs are transmitted without repetition according to some embodiments of the present disclosure;

FIG. 18 illustrates an example TDM arrangement where the two TBs are transmitted with mini-slot based repetition according to some embodiments of the present disclosure;

FIG. 19 illustrates an example TDM arrangement where the two TBs are transmitted with mini-slot based repetition, and TB1 and TB2 are provided with different number of repetitions according to some embodiments of the present disclosure;

FIG. 20 illustrates an example TDM arrangement where the two TBs are transmitted with slot-based repetition according to some embodiments of the present disclosure;

FIG. 21 illustrates an example TDM arrangement where the two TBs are transmitted with slot-based repetition, where TB1 and TB2 are provided with different number of repetitions according to some embodiments of the present disclosure;

FIG. 22 illustrates an example Hybrid TDM FDM arrangement where TB1 is allocated a subset of the REs according to some embodiments of the present disclosure;

FIG. 23 illustrates an example of multiplexing of two transport blocks with separate deadlines/timing requirements according to some embodiments of the present disclosure;

FIG. 24 illustrates an example of the WD being pre-configured with plurality of options for the transmissions and network node instructing WD which option to follow for every transmission according to some embodiments of the present disclosure;

FIG. 25 illustrates an example where some SPSs' PDSCHs are cancelled (left hand side, due to prioritization) and if WD is provided with multiple options for a given transmission, then network node selects the best suited option and able to transmit partially (in right hand side), over the resource meant for SPS ID#2 than in left hand side according to some embodiments of the present disclosure; and

FIG. 26 illustrates an example of a WD configured with 3 options for TB transmission over an SPS#2 according to some embodiments of the present disclosure.

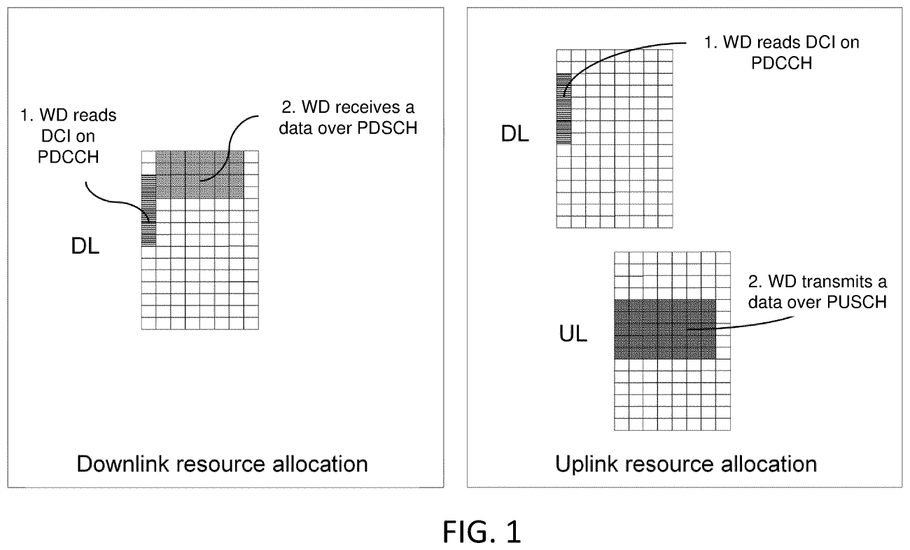

### DETAILED DESCRIPTION

When a WD has multiple flows of data with different Quality-of-Service (QoS) characteristics, it may be desired to use different modulation, error correction coding rate, coding technique (code) or different power. In 3GPP LTE (4G) and NR (5G) this can be achieved only by sending separate scheduling commands/grants. Moreover, such transmissions can only be time division multiplexed (TDM-ed) (i.e., do not overlap in time). Those limitations lead to usage of non-spectral efficient features (such as prioritization and pre-emption), lead to delays with risk of non-achieving QoS targets and, finally, to control channel overheads which also decreases spectral efficiency.

Some embodiments of the present disclosure provide methods, arrangements and algorithms for efficient data transmission scheduling in UL and DL, e.g., when the WD/UE runs multiple services with different QoS characteristics.

Some embodiments of the present disclosure provide methods and algorithms to increase spectral efficiency in scenarios when a WD/UE transmits and/or receives multiple data flows with different QoS characteristics. In a nutshell, in some embodiments, instead of scheduling multiple transmissions with different reliability target back-to-back at the physical (PHY) layer (i.e., open systems interconnect (OSI) physical layer), one can schedule a single transmission partitioned in desired way. Some embodiments of the present disclosure may provide for higher efficiency to be achieved by using only one set of demodulation reference signal (DMRS) for transmission and by a possibility of using less downlink control resources compared to legacy method such as LTE (i.e., back-to-back transmissions scheduling).

Before describing in detail example embodiments, it is noted that the embodiments reside primarily in combinations of apparatus components and processing steps related to methods and algorithms of data multiplexing at a physical (PHY) layer. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Receiving (or obtaining) information/signaling (e.g., control information, scheduling information, etc.) may comprise receiving one or more information messages. In some embodiments, it may be considered that receiving signaling comprises demodulating and/or decoding. In some embodiments, it may be considered that transmitting such signaling comprises modulating and/or encoding the signaling. In some embodiments, it may be assumed that both sides of the communication are aware of the scheduling information and/or may transmit the multiple TBs described herein according to the scheduling and/or configuration information (NN 16 transmits DL transmissions, WD 22 transmits UL transmissions).

In some embodiments, receiving signaling may comprise detecting, e.g. blind detection of, one or more messages, in particular a message carried by the signaling, e.g.

based on an assumed set of resources, which may be searched and/or listened for the control information. It may be assumed that both sides of the communication are aware of the configurations, and may determine the set of resources, e.g. based on the reference size.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the network node is the transmitter and the receiver is the WD. For the UL communication, the transmitter is the WD and the receiver is the network node.

Any two or more embodiments described in this disclosure may be combined in any way with each other.

The term “signaling” used herein may comprise any of: high-layer signaling (e.g., via Radio Resource Control (RRC) or a like), lower-layer signaling (e.g., via a physical control channel or a broadcast channel), or a combination thereof The signaling may be implicit or explicit. The signaling may further be unicast, multicast or broadcast. The signaling may also be directly to another node or via a third node.

Generally, it may be considered that the network, e.g. a signaling radio node and/or node arrangement (e.g., network node), configures a WD, in particular with the transmission resources. A resource may in general be configured with one or more messages. Different resources may be configured with different messages, and/or with messages on different layers or layer combinations. The size of a resource may be represented in symbols and/or subcarriers and/or resource elements and/or physical resource blocks (depending on domain), and/or in number of bits it may carry, e.g. information or payload bits, or total number of bits. The set of resources, and/or the resources of the sets, may pertain to the same carrier and/or bandwidth part, and/or may be located in the same slot, or in neighboring slots.

In some embodiments, control information on one or more resources may be considered to be transmitted in a message having a specific format. A message may comprise or represent bits representing payload information and coding bits, e.g., for error coding.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may, for example, be based on position and/or resource used for transmission. Explicit indication may, for example, be based on a parametrization with one or more parameters, and/or one or more index or indices corresponding to a table, and/or one or more bit patterns representing the information.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have at least two component channels, one for each direction. Examples of channels comprise a channel for low latency and/or high reliability transmission, in particular a channel for Ultra-Reliable Low Latency Communication (URLLC), which may be for control and/or data.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

As used herein, a repetition of a transport block refers to a set of coded bits that are generated for the transport block. Two different repetitions of a transport block may transmit the same set of coded bits for the given transport block, or transmit different sets of coded bits for the given transport block. A way to provide the set of coded bits for a transport block is to use the redundancy version (RV) on a circular buffer of coded bits for the TB, where N coded bits are read from the circular buffer starting from the location provided by the RV. Thus, a j-th repetition of the TB transmits N(j) coded bits of the given TB starting from location of RV(j) on the circular buffer for the TB. Different repetitions of the TB may or may not use the same RV value, and may or may not use the same N value. When scheduling the transmission of a TB with repetition, two or more repetitions of the given TB are scheduled.

Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

Configuring in General

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

A resource element may represent a smallest time-frequency resource, e.g. representing the time and frequency range covered by one symbol or a number of bits represented in a common modulation. A resource element may e.g. cover a symbol time length and a subcarrier, in particular in 3GPP and/or LTE standards. A data transmission may represent and/or pertain to transmission of specific data, e.g. a specific block of data and/or transport block.

In some embodiments, the general term “resource” is intended to indicate a frequency resource, and/or a time resource. In some embodiments, the general term “resource allocation” is intended to indicate a frequency resource allocation and/or a time resource allocation.

The term time resource used herein may correspond to any type of physical resource or radio resource expressed in terms of length of time. Examples of time resources are: symbol, time slot, sub-slot, subframe, radio frame, TTI, interleaving time, etc. As used herein, in some embodiments, the terms “subframe,” “slot,” “sub-slot”, “sub-frame/slot” and “time resource” are used interchangeably and are intended to indicate a time resource.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

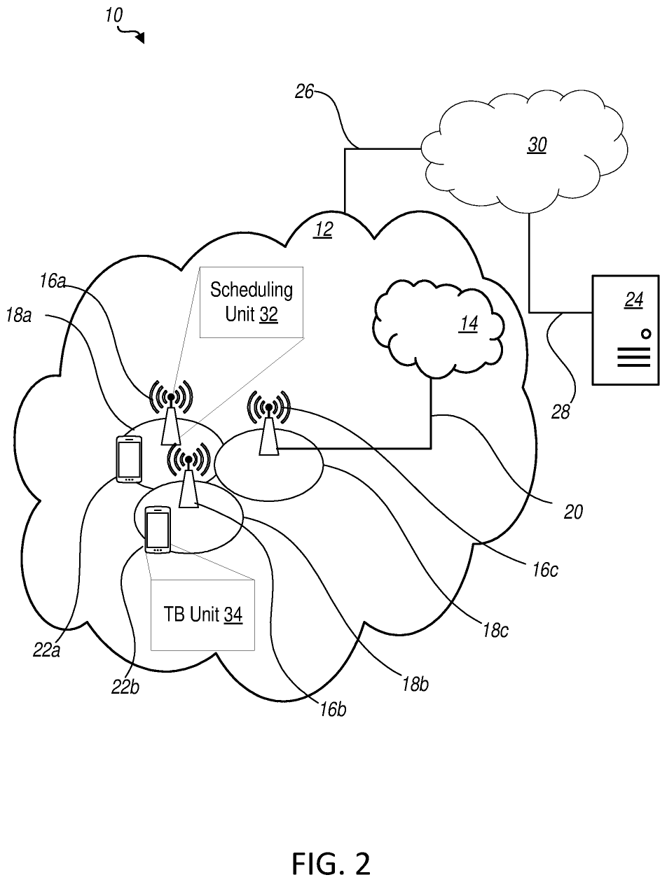

Some embodiments provide methods and algorithms of data multiplexing at a physical (PHY) layer. Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a scheduling unit 32 which is configured to cause the network node 16 to schedule a transmission comprising a plurality of transport blocks (TBs); and receive and/or transmit the transmission comprising the plurality of TBs based on the scheduling.

A wireless device 22 is configured to include a transport block (TB) unit 34 which is configured to cause the WD 22 to receive signaling, the signaling scheduling a transmission comprising a plurality of transport blocks (TBs); and receive and/or transmit the transmission comprising the plurality of TBs based on the scheduling.

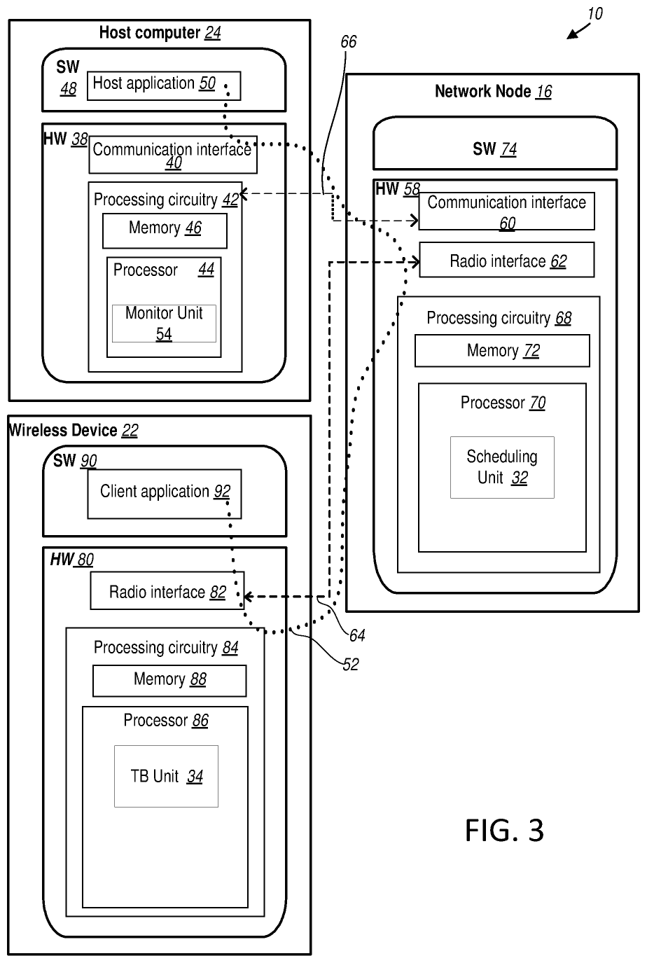

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

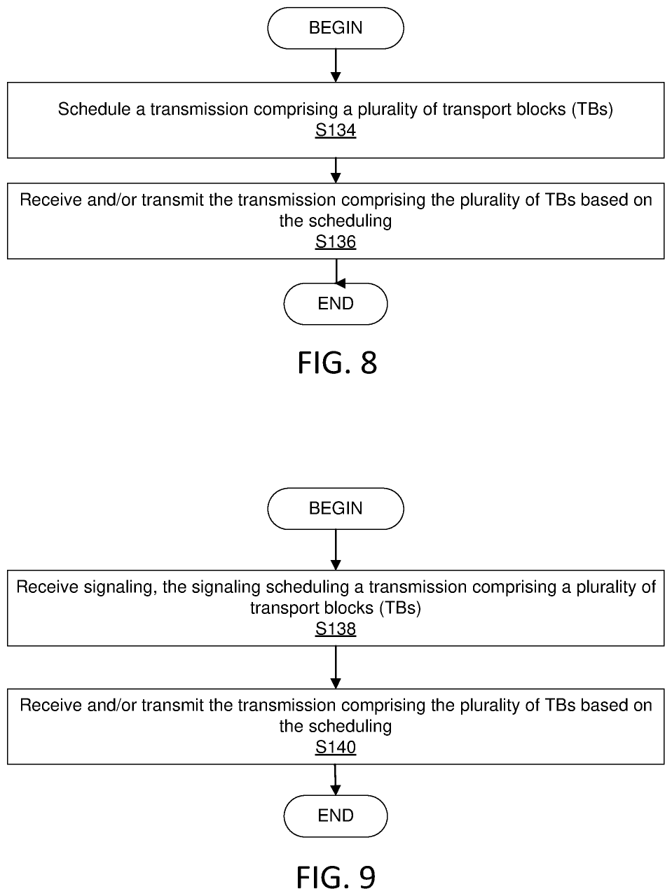

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include scheduling unit 32 configured to perform network node methods discussed herein, such as the methods discussed with reference to FIG. 8 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a TB unit 34 configured to perform WD methods discussed herein, such as the methods discussed with reference to FIG. 9 as well as other figures.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as scheduling unit 32, and TB unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

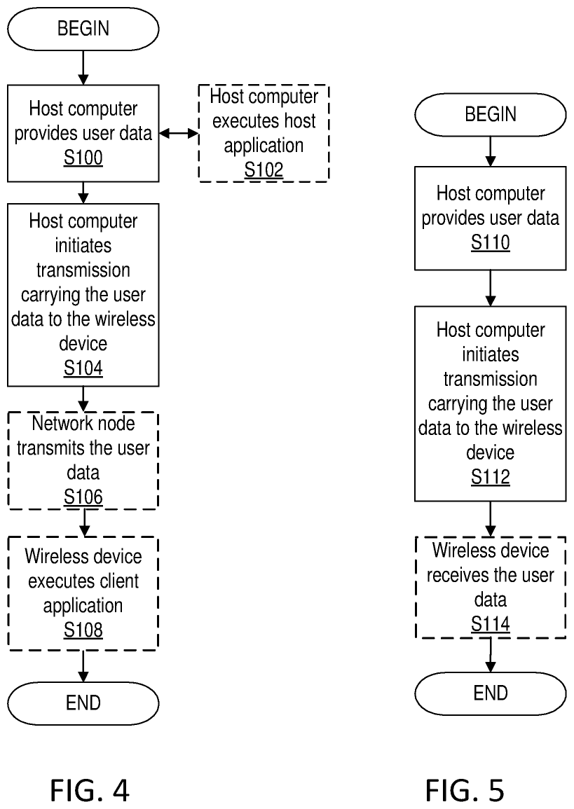

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

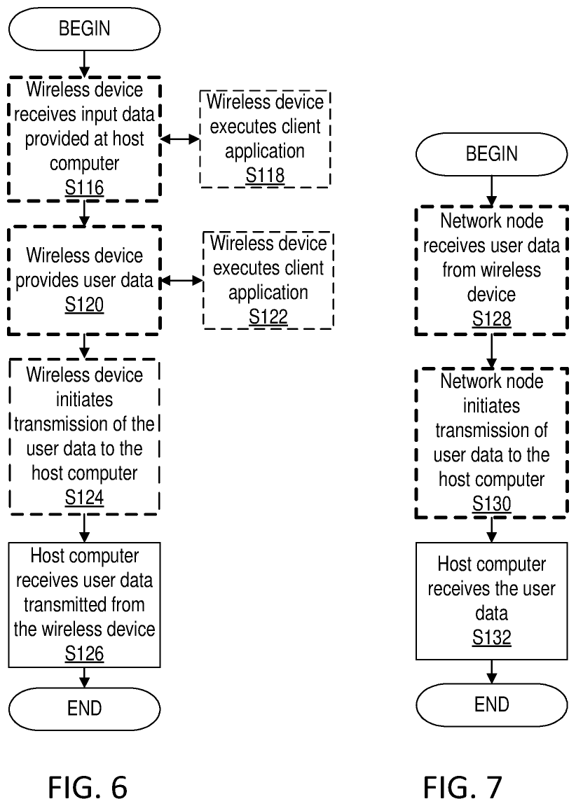

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 8 is a flowchart of an example process in a network node 16 according to some embodiments of the present disclosure. One or more Blocks and/or functions and/or methods performed by the network node 16 may be performed by one or more elements of network node 16 such as by scheduling unit 32 in processing circuitry 68, processor 70, communication interface 60, radio interface 62, etc. according to the example method. The example method includes scheduling (Block S134), such as via scheduling unit 32, processing circuitry 68, processor 70, communication interface 60 and/or radio interface 62, a transmission comprising a plurality of transport blocks (TBs). The method includes receiving and/or transmitting (Block S136), such as via scheduling unit 32, processing circuitry 68, processor 70, communication interface 60 and/or radio interface 62, the transmission comprising the plurality of TBs based on the scheduling.

In some embodiments, one or more of:
at least one TB of the plurality of TBs in the scheduled transmission has a different Quality-of-Service (QoS) than at least one other TB;
the scheduling of the transmission comprising the plurality of TBs is in a single downlink control information (DCI) message;
the scheduling of the transmission comprising the plurality of TBs is in a single radio resource control (RRC) message;
the transmission is a single transmission partitioned to include the plurality of TBs; and/or
one set of demodulation reference signal (DMRS) is used for the transmission.

FIG. 9 is a flowchart of an example process in a wireless device 22 according to some embodiments of the present disclosure. One or more Blocks and/or functions and/or methods performed by WD 22 may be performed by one or more elements of WD 22 such as by TB unit 34 in processing circuitry 84, processor 86, radio interface 82, etc. The example method includes receiving (Block S138), such as via TB unit 34, processing circuitry 84, processor 86 and/or radio interface 82, signaling scheduling a transmission comprising a plurality of transport blocks (TBs). The method includes receiving and/or transmitting (Block S140) the transmission comprising the plurality of TBs based on the scheduling. In some embodiments, one or more of:
at least one TB of the plurality of TBs in the scheduled transmission has a different Quality-of-Service (QoS) than at least one other TB;
the scheduling of the transmission comprising the plurality of TBs is in a single downlink control information (DCI) message;
the scheduling of the transmission comprising the plurality of TBs is in a single radio resource control (RRC) message;
the transmission is a single transmission partitioned to include the plurality of TBs; and/or
one set of demodulation reference signal (DMRS) is used for the transmission.

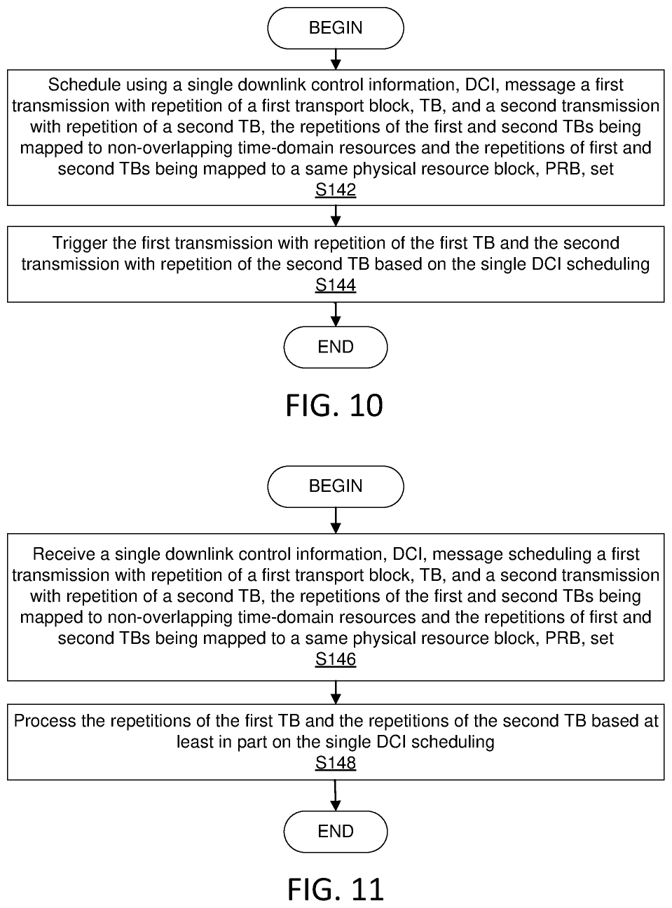

FIG. 10 is a flowchart of an example process in a network node 16 according to some embodiments of the present disclosure. One or more Blocks and/or functions and/or methods performed by the network node 16 may be performed by one or more elements of network node 16 such as by scheduling unit 32 in processing circuitry 68, processor 70, communication interface 60, radio interface 62, etc. according to the example method. The example method includes scheduling (Block S142), such as via scheduling unit 32, processing circuitry 68, processor 70, communication interface 60 and/or radio interface 62, using a single downlink control information, DCI, message a first transmission with repetition of a first transport block, TB, and a second transmission with repetition of a second TB, the repetitions of the first and second TBs being mapped to non-overlapping time-domain resources and the repetitions of first and second TBs being mapped to a same physical resource block, PRB, set. The method includes triggering (Block S144), such as via scheduling unit 32, processing circuitry 68, processor 70, communication interface 60 and/or radio interface 62, the first transmission with repetition of the first TB and the second transmission with repetition of the second TB based on the single DCI scheduling.

In some embodiments, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments, the first transmission with repetition comprises a mini-slot repetition of the first TB and the second transmission with repetition comprises a mini-slot repetition of the second TB. In some embodiments, the first transmission with repetition comprises a slot-based repetition of the first TB and the second transmission with repetition comprises a slot-based repetition of the second TB.

In some embodiments, the first transmission with repetition comprises a mini-slot repetition of the first TB and the second transmission with repetition comprises a slot-based repetition of the second TB. In some embodiments, the repetitions of at least one of the first TB and the repetitions of the second TB are time-domain consecutive. In some embodiments, the repetitions of at least one of the first TB and the second TB are separated by a pre-configured time-domain gap. In some embodiments, the first transmission comprises a first number of repetitions of the first TB and the second transmission comprises a second number of repetitions of the second TB, the first number being different than the second number.

In some embodiments, the scheduling in the single DCI message comprises scheduling, such as via scheduling unit 32, processing circuitry 68, processor 70, communication interface 60 and/or radio interface 62, a physical uplink shared channel, PUSCH, in the single DCI, the scheduled PUSCH comprising the repetitions of the first and second TBs. In some embodiments, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission.

In some embodiments, the first TB and the second TB are scheduled for transmission by the network node. In some embodiments, the first TB and the second TB are scheduled for transmission by the wireless device. In some embodiments, a repetition of at least one of the first and second TB is skipped.

FIG. 11 is a flowchart of an example process in a wireless device 22 according to some embodiments of the present disclosure. One or more Blocks and/or functions and/or methods performed by WD 22 may be performed by one or more elements of WD 22 such as by TB unit 34 in processing circuitry 84, processor 86, radio interface 82, etc. The example method includes receiving (Block S146), such as via TB unit 34, processing circuitry 84, processor 86 and/or radio interface 82, a single downlink control information, DCI, message scheduling a first transmission with repetition of a first transport block, TB, and a second transmission with repetition of a second TB, the repetitions of the first and second TBs being mapped to non-overlapping time-domain resources and the repetitions of first and second TBs being mapped to a same physical resource block, PRB, set. The method includes processing (Block S148), such as via TB unit 34, processing circuitry 84, processor 86 and/or radio interface 82, the repetitions of the first TB and the repetitions of the second TB based at least in part on the single DCI scheduling.

In some embodiments, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments, the first transmission with repetition comprises a mini-slot repetition of the first TB and the second transmission with repetition comprises a mini-slot repetition of the second TB. In some embodiments, the first transmission with repetition comprises a slot-based repetition of the first TB and the second transmission with repetition comprises a slot-based repetition of the second TB.

In some embodiments, the first transmission with repetition comprises a mini-slot repetition of the first TB and the second transmission with repetition comprises a slot-based repetition of the second TB. In some embodiments, the repetitions of at least one of the first TB and the repetitions of the second TB are time-domain consecutive. In some embodiments, the repetitions of at least one of the first TB and the second TB are separated by a pre-configured time-domain gap. In some embodiments, the first transmission comprises a first number of repetitions of the first TB and the second transmission comprises a second number of repetitions of the second TB, the first number being different than the second number.

In some embodiments, the scheduling in the single DCI message comprises scheduling, such as via TB unit 34, processing circuitry 84, processor 86 and/or radio interface 82, a physical uplink shared channel, PUSCH, in the single DCI, the scheduled PUSCH comprising the repetitions of the first and second TBs. In some embodiments, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission.

In some embodiments, the first TB and the second TB are scheduled for transmission by the network node. In some embodiments, the first TB and the second TB are scheduled for transmission by the wireless device. In some embodiments, a repetition of at least one of the first and second TB is skipped.

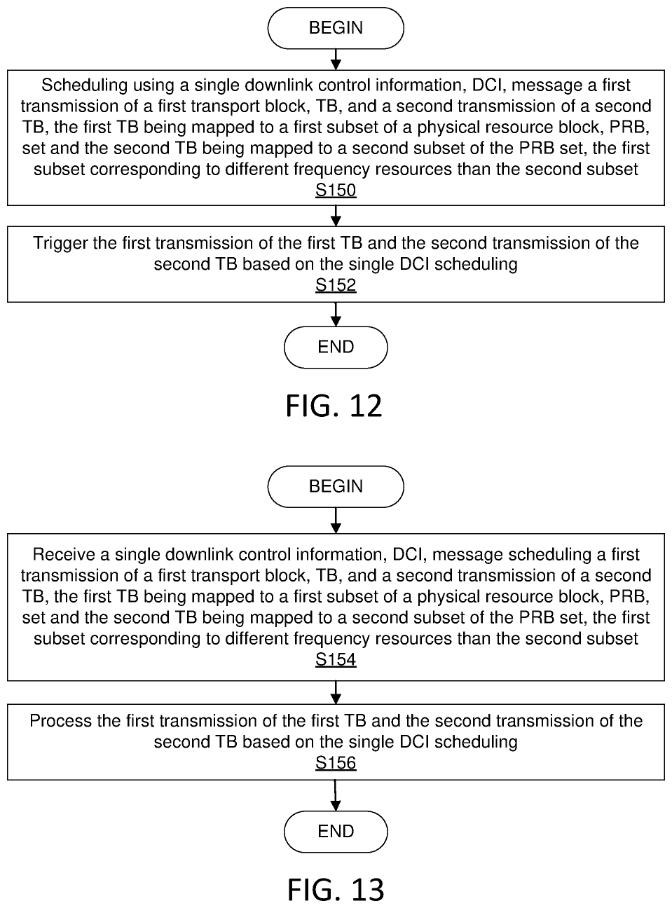

FIG. 12 is a flowchart of an example process in a network node 16 according to some embodiments of the present disclosure. One or more Blocks and/or functions and/or methods performed by the network node 16 may be performed by one or more elements of network node 16 such as by scheduling unit 32 in processing circuitry 68, processor 70, communication interface 60, radio interface 62, etc. according to the example method. The example method includes scheduling (Block S150), such as via scheduling unit 32, processing circuitry 68, processor 70, communication interface 60 and/or radio interface 62, using a single downlink control information, DCI, message a first transmission of a first transport block, TB, and a second transmission of a second TB, the first TB being mapped to a first subset of a physical resource block, PRB, set and the second TB being mapped to a second subset of the PRB set, the first subset corresponding to different frequency resources than the second subset. The method includes triggering (Block S152), such as via scheduling unit 32, processing circuitry 68, processor 70, communication interface 60 and/or radio interface 62, the first transmission of the first TB and the second transmission of the second TB based on the single DCI scheduling.

In some embodiments, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments, the first and second TBs are mapped to non-overlapping time-domain resources. In some embodiments, the first and second TBs are mapped to overlapping time-domain resources. In some embodiments, the first transmission is with repetition of the first TB and the second transmission is with repetition of the second TB.

In some embodiments, the first transmission is without repetition of the first TB and the second transmission is with repetition of the second TB. In some embodiments, at least one of: a first number of PRBs corresponding to the first transmission of the first TB is different from a second number of PRBs corresponding to the second transmission of the second TB; and a first number of orthogonal frequency division multiplexing, OFDM, symbols corresponding to the first transmission of the first TB is different from a second number of OFDM symbols corresponding to the second transmission of the second TB. In some embodiments, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission. In some embodiments, the first TB and the second TB are scheduled for transmission by the network node. In some embodiments, the first TB and the second TB are scheduled for transmission by the wireless device.

FIG. 13 is a flowchart of an example process in a wireless device 22 according to some embodiments of the present disclosure. One or more Blocks and/or functions and/or methods performed by WD 22 may be performed by one or more elements of WD 22 such as by TB unit 34 in processing circuitry 84, processor 86, radio interface 82, etc. The example method includes receiving (Block S154), such as via TB unit 34, processing circuitry 84, processor 86 and/or radio interface 82, a single downlink control information, DCI, message scheduling a first transmission of a first transport block, TB, and a second transmission of a second TB, the first TB being mapped to a first subset of a physical resource block, PRB, set and the second TB being mapped to a second subset of the PRB set, the first subset corresponding to different frequency resources than the second subset. The method includes processing (Block S156) the first transmission of the first TB and the second transmission of the second TB based on the single DCI scheduling.

In some embodiments, the first TB is associated with a first value for a scheduling parameter and the second TB is associated with a second value for the scheduling parameter, the scheduling parameter comprising one of a modulation and coding scheme, MCS, a redundancy version, RV, a priority, a hybrid automatic repeat request, HARQ, identifier, ID, and a Quality-of-Service, QoS, requirement. In some embodiments, the first and second TBs are mapped to non-overlapping time-domain resources. In some embodiments, the first and second TBs are mapped to overlapping time-domain resources. In some embodiments, the first transmission is with repetition of the first TB and the second transmission is with repetition of the second TB. In some embodiments, the first transmission is without repetition of the first TB and the second transmission is with repetition of the second TB.

In some embodiments, at least one of: a first number of PRBs corresponding to the first transmission of the first TB is different from a second number of PRBs corresponding to the second transmission of the second TB; and a first number of orthogonal frequency division multiplexing, OFDM, symbols corresponding to the first transmission of the first TB is different from a second number of OFDM symbols corresponding to the second transmission of the second TB. In some embodiments, the single DCI indicates the scheduling of the first and second transmission according to at least one of: a DCI field indicating use of a multi-TB transmission; a priority field value indicating use of the multi-TB transmission; a value in a time-domain resource allocation, TDRA, table indicating a number of TBs; a radio network temporary identifier, RNTI, indicating use of the multi-TB transmission; and a DCI format indicating use of the multi-TB transmission.

Having described the general process flow of arrangements of the disclosure and having provided examples of hardware and software arrangements for implementing the processes and functions of the disclosure, the sections below provide details and examples of arrangements for methods and algorithms of data multiplexing at a physical (PHY) layer, which may be implemented by the network node 16, wireless device 22 and/or host computer 24.

General Description

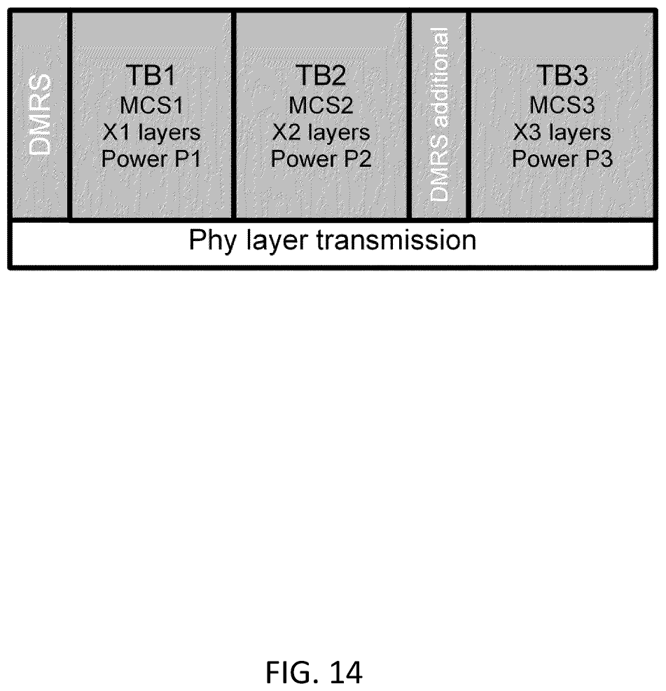

In some embodiments, when there are multiple traffic flows going to/from wireless device 22 and those traffic flows have different QoS requirements, network node 16 (e.g., gNB) can schedule one PHY layer transmission which carries two or more channels transport blocks. In this case, single PHY layer transmission can be considered as multiple containers for data (as two or more separate assignments/grants from higher layers perspective). Each transport block may be encoded and mapped to the time-frequency grid differently (e.g., by one or more of different: channel code, code rate, modulation, multiple-input multiple-output/MIMO precoding, power, etc.), but, in some embodiments, at the same time only one DMRS set is used and only one scheduling command is used (e.g., dynamic or pre-scheduling/configured grant), see example in FIG. 14. Some embodiments can be applied for uplink and downlink transmissions. FIG. 14 shows an example of single PHY layer transmission with multiple transport blocks.

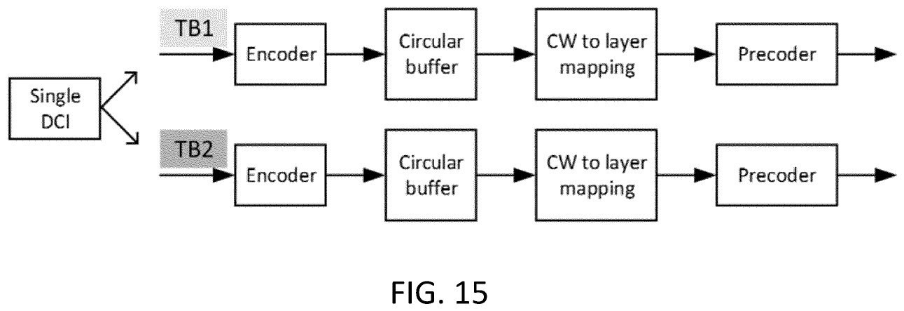

In FIG. 15 is a showing a single DCI scheduling two TBs: TB1 and TB2. The two TBs are used to carry traffic data of different requirements (e.g., QoS requirements), for example, via mapping of two separate logical channels. For convenience of discussion, it is assumed that TB1 carries URLLC data, while TB2 carries enhanced Mobile Broadband (eMBB) data. The same diagram, signaling, and design principles may be applied if more than two TBs are desired.

In some embodiments, for the arrangements described herein, the transmission (e.g., the TBs) can use e.g., a single transmission/reception point (TRP) or multiple TRPs:
If single TRP, then the DMRS can be shared between the different TBs.
On the other hand, if different TBs are sent from different TRPs, then the DMRS sent by different TRPs cannot be used jointly in the TB reception. Thus, each TB has its own DMRS, and there is separate grouping of {TB1, TRP1, DMRS1} and {TB2, TRP2, DMRS2}.

In some embodiments, for the arrangements herein, different TBs can use a different modulation order.

FDM Arrangement

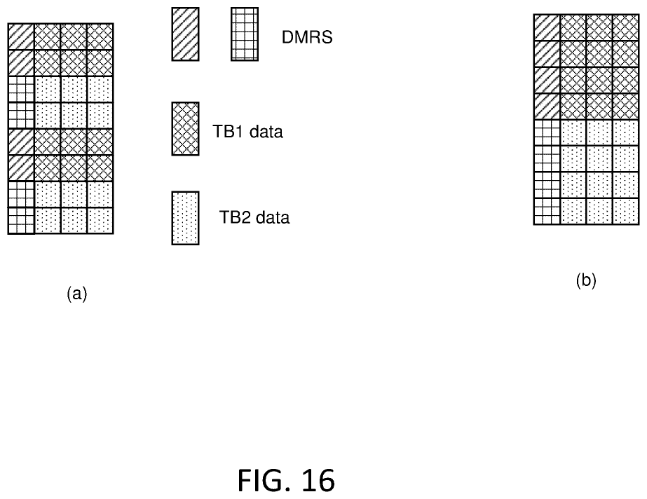

In some embodiments, to ensure reliability of TB1 (e.g., URLLC traffic), the two TBs are mapped to non-overlapping frequency resources. In the time domain, the two TB occupy the same resources. An example is illustrated in FIG. 16.

In some embodiments, the frequency domain partition can use any one or more of the following arrangements:
(a) Interlacing frequency domain resources between the TBs. For example, define a physical resource block (PRB) group (PRG) size, e.g., PRG=2 PRB or 4 PRB, and even-numbered PRGs are used for TB1, odd-numbered PRGs are used for TB2. This is illustrated in (a) in FIG. 16.
(b) Divide the total allocated frequency resources into two parts, with one part for TB1 and the other part for TB2. The two parts may have the same size. Alternatively, the two parts may be allocated unequally, for example, to account for the different performance requirements of TB1 and TB2. This is illustrated in (b) in FIG. 16.

TDM Arrangement

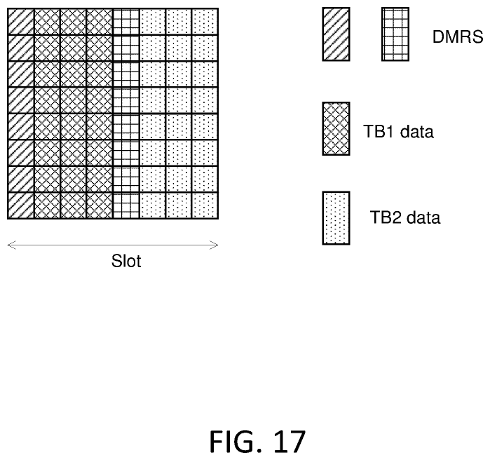

In some embodiments, with the TDM arrangements, the two TBs are mapped to non-overlapping time-domain resources. In some embodiments, in the frequency domain, the two TB occupy the same set of PRBs. An example of this is illustrated in FIG. 17.

In some embodiments, the time domain resources of TB1 and TB2 may be consecutive (as illustrated FIG. 17), or separated with a pre-configured gap (not illustrated). FIG. 17 illustrates an example TDM arrangement where the two TBs are transmitted without repetition.

In some embodiments, the TDM arrangement can be further configured with repetition. Depending on time domain units for repetition, the repetition may use mini-slot level repetition or slot level repetition, as discussed in sub-sections below. In some embodiments, TB1 and TB2 may use different number of repetitions, for example, for account for the different performance requirements of the TBs.

TDM Arrangement With Mini-Slot Repetition

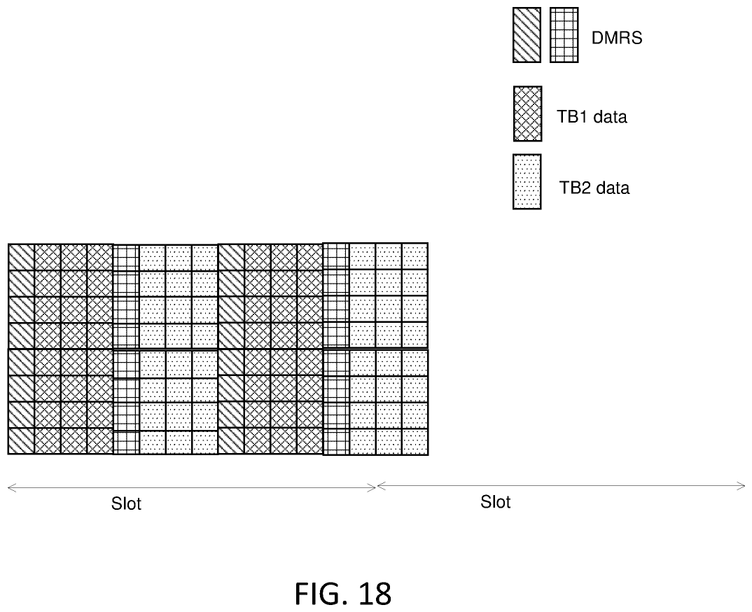

In some embodiments, using the TDM arrangement with mini-slot repetition, each TB is transmitted with units of mini-slots, where the mini-slot is a fraction of the whole slot. The mini-slots of each TB may be repeated in the time domain. While the mini-slots are shown as consecutive in FIG. 18, it is also possible that the mini-slots are not consecutive, e.g., separated with pre-configured gaps between some or all of the mini-slots. FIG. 18 illustrates an example TDM arrangement where the two TBs are transmitted with mini-slot based repetition.

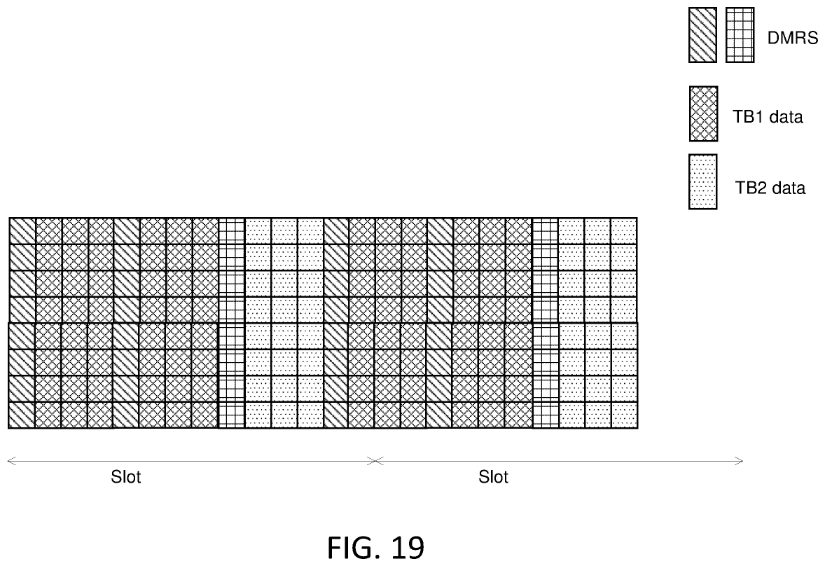

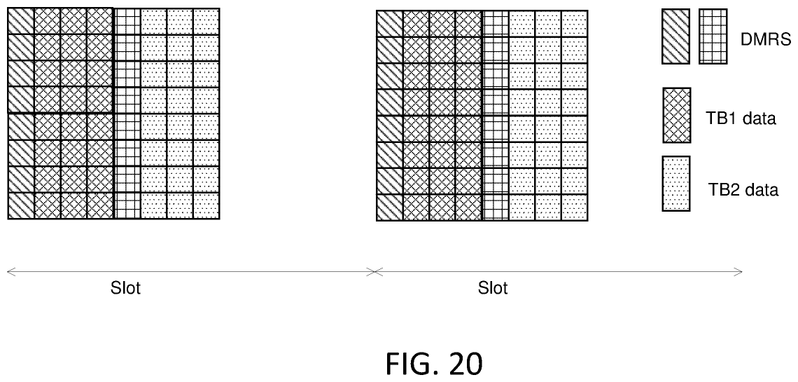

In some embodiments, the amount of repetition can be configured to be different between the TBs. For example, TB1 carries URLLC data and has lower block error rate (BLER) target (e.g., BLER=1e-5), hence TB1 is configured with more repetitions. In contrast, TB2 carries eMBB data and has higher BLER target (e.g., BLER=0.1), hence TB2 is configured with no repetition or fewer repetitions. This is illustrated in FIG. 19, as an example. FIG. 19 illustrates an example TDM arrangement where the two TBs are transmitted with mini-slot based repetition, and TB1 and TB2 are provided with different number of repetitions.

TDM Arrangement With Slot-Based Repetition

In some embodiments, using the TDM arrangement with slot-based repetition, transmission of the TBs is allocated resources in a first slot, and subsequently repeated in a second slot, where the transmission occupies the same location in both first and second slots. An example is shown in FIG. 20. FIG. 20 illustrates the example TDM arrangement where the two TBs are transmitted with slot-based repetition.

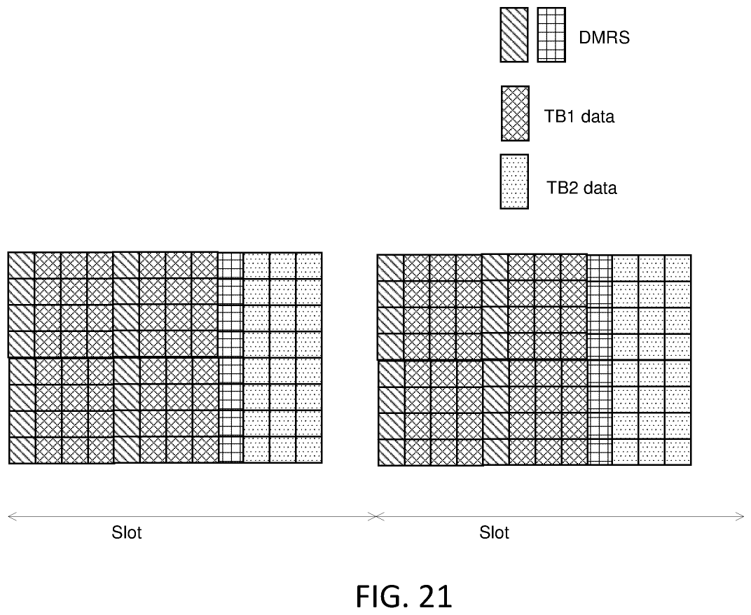

Similarly, different TBs may be configured with different amounts of repetitions. One example is illustrated in FIG. 21, where TB1 is configured with more repetitions than TB2. Also, the example in FIG. 21 illustrates that the repetition can use a combination of mini-slot based and slot-based repetitions. FIG. 21 illustrates the example TDM arrangement where the two TBs are transmitted with slot-based repetition, where TB1 and TB2 are provided with different number of repetitions.

Hybrid TDM FDM Arrangement

In one set of embodiments, both TDM and FDM may be used. This may be beneficial if e.g., the number of resources needed by the two TBs differ a lot, or if one TB needs to be decoded faster due to packet delay budget constraints. Using the TDM arrangement, the delay sensitive packet can be scheduled earlier allowing for early decoding, but then it takes up all PRBs, which might lead to inefficient use of resources if the needed number of resources by the TB is small. Conversely, if the FDM arrangement is used, then all orthogonal frequency division multiplexing (OFDM) symbols are used for the TB, which might cause the packet delay budget to be exceeded if the number of OFDM symbols allocated is large to account for a large TB size of the other TB. In the hybrid arrangements, both the number of PRBs allocated and the number of OFDM symbols allocated for the two or more TBs may be allowed to vary.

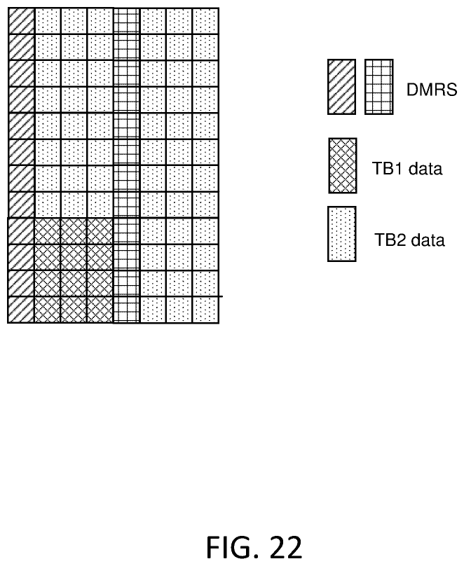

FIG. 22 illustrates an example Hybrid TDM FDM arrangement where TB1 is allocated a subset of the resource elements (REs). In some embodiments, signaling and which PRBs and OFDM symbols to allocate can be used as in the TDM arrangements, and the FDM arrangements.

Concatenated or Multiplexed Bit-Stream Arrangements

In one set of embodiments, the coded bits from different TBs may be combined into a single bit-sequence before mapping to different layers and REs.

In existing arrangements, several code blocks (CBs) are concatenated before mapping to physical resources. All CBs have approximately the same size in number of information bits and number of coded bits. In contrast, in some embodiments of the present disclosure, the two TBs are not concatenated together before mapping, to physical resources, but each TB may be mapped to a different set of layers (e.g., OSI layers, physical layers, etc.).

The rationale may be that the two TBs have a significant difference in transport block size (TBS), reliability target and hence coding rate. If the URLLC packet is very small, allocating a full OFDM symbol to it, or an integer number of layers will give it too many resources. This may be why URLLC and eMBB data may be concatenated on higher layers. However, this does not allow for separate MCS selection for the URLLC packet.

In one version of this embodiment, the bits from different TBs are concatenated after the code block concatenation step. Compared to the prior art, this allows for combination of two TBS with a significant difference in the number of coded bits. This can be especially useful when a small URLLC message in TB1 is combined with a large eMBB message in TB2. In some embodiments, when the combining is based on FDM, TDM, or whole layers, the number of coded bits for the URLLC message is given by the allocation in frequency, time, or number of layers respectively. In some embodiments, allocating a full PRB, OFDM symbol, or layer would allocate more than the desired number of resources to TB1. When using the FDM methods described above, all OFDM symbols in a PRB allocated to a TB may be used for the TB. In this case all OFDM symbols in the transmission is to be received before decoding the TB, and this might cause unnecessary delay for the URLLC message.

In one version of the embodiment, the bits from different TBs are interleaved before mapping to constellation symbols. In NR, when using quadrature amplitude modulation (QAM) with modulation order larger than 2 bits per QAM modulation symbol, different bit positions will have different reliability when demodulated. The more significant bits (i.e., the earlier bits) in a set of bits that map to the same QAM symbol will generally be more reliable. The reliability ordering decreases in pairs, i.e., the first two bits have the same reliability, which is higher than the reliability of the third and fourth bits, and the reliability of the third and fourth bits is the same. An explicit example of this is when the output after code block concatenation of TB1 is given by a0, a1, . . . , aN1-1, and the output after code block concatenation of TB2 is given by b0, b1, . . . , bN2-1. Then the interleaving when using 16 QAM (modulation order 4) could be a0, a1, b0, b1, a2, a3, b2, b3, . . . . Each constellation symbol corresponds to 4 bits, and the most reliable bits are used for TB1. This may be especially useful when the sizes of the two TBs vary by a lot. If the URLLC message is small in size compared to the eMBB message, the URLLC message can be transmitted on a comparatively small subset of resources elements compared to the eMBB message. By allocating the more reliable bit positions to TB1 it may be possible to use the same modulation order for the whole transmission, simplifying demodulation, while still achieving low enough BLER for the URLLC message.

In NR, low density parity check (LDPC) codes different bits of the same TB have different protection. In contrast, in some embodiments of the proposed arrangement different TBs have different protection, with one TB having higher protection. One reason may be that the two TBs have different reliability targets and coding rates. Consider an example where the URLLC packet is 32 bytes and the eMBB packet is very large. To achieve good spectral efficiency high modulation order may be used for the eMBB packet. Using the same modulation order for the URLLC packet deteriorates performance. Instead, the URLLC packet can be mapped to the high reliability bit positions, achieving better performance than using high order modulation.

Determining the number of coded bits for different TBs can be performed using methods discussed in more detail below with regard to signaling aspect.

Different variations of the above arrangement are possible. If the modulation order is 6, (64 QAM), then there may be three different reliability levels. Here, either the first level (i.e.

two bits), can be used for TB1, and the rest for TB2, or the first two levels, i.e., four bits are used for TB1 and the rest for TB2.

In some embodiments, a simple variation may include filling in the most reliable bit positions with bits from one of the codewords (CWs), until all the bits from that codeword has been used. Then the most reliable unused bit positions are filled with bits from the next codeword, etc.

Signaling Aspects

In some embodiments, there are following ways (which may be performed by NN 16 and/or received by WD 22) to trigger/enable multiple TB transmission according to some embodiments of the present disclosure, e.g.:
Whether a transmission includes multiple TBs may be semi-statically configured by radio resource control (RRC) (e.g., N number of TBs may be signaled to the WD 22 via RRC signaling).
   Every time when resources are granted, the WD 22 may assume that there are N TBs e.g., based on the RRC signaling.
Whether a transmission includes multiple TBs is dynamically signaled with the scheduling command, e.g.:
   Separate field in DCI is used to indicate multi-TB transmission or even number of TBs to transmit.
   Presence of priority field or certain value of priority field triggers multi-TB transmission.
   Number of TBs is encoded in time-domain resource allocation (TDRA) table.
   Separate radio network temporary identifier (RNTI) is used as indication e.g., of multi-TB transmission.
   Usage of certain DCI format (e.g. 0_2 or 1_2) can be an indicator e.g., of multi-TB transmission.

In some embodiments, to be able to derive N transport block size (TBS), certain fraction of allocated resources can be semi-statically configured, e.g., N=3, f_{TB1}=0.3, f_{TB2}=0.3, f_{TB3}=1−f_{TB1}−f_{TB2}. As an alternative, the fraction, f, for each TB can be signaled as a separate field in DCI or added as a column in TDRA table.

In some embodiments, TBs can have different MCSs. One transport block can use an MCS index provided in the scheduling DCI or configured in the pre-scheduling configuration. MCS for another transport block can be defined as an index offset to the first TB, e.g. “−3” means MCS index for the second TB is 3 steps less or zero (since MCS index cannot be smaller than zero). Alternatively, there can be an explicit bitfield in scheduling command, e.g., scheduling DCI.

In some embodiments, a redundancy version (RV) sequence for all TBs can be the same. Alternatively, in some embodiments, multiple RV fields are provided in the DCI (one for each TB).

In some embodiments, when a dynamically scheduled transmission (e.g., DCI) overlaps with a DL semi-persistent (SPS), or UL configured (CG) transmission, multiplexing may be triggered. In some embodiments, the multiplexing may be triggered only if the DL SPS or UL CG transmission is of a high priority.

In addition, in some embodiments, other parameters like MCS, priority, etc. can be set the same or different for different TBs.

Timeline Aspects

When TB multiplexing transmission is scheduled, some embodiments may include checking whether WD 22 will have enough time to decode the scheduling command and:
(DL) decode TBs in downlink in time before expected hybrid automatic repeat request (HARQ-ACK) transmission; and/or
(UL) prepare UL transmission.

In one embodiment, additional delay is added in the formula for timeline check, e.g., dₓ=Y OFDM-symbols or milliseconds (ms). Having NR as an example, additional term may be added to formulas for T_{proc,1} or T_{proc,2} calculations (e.g., where T may represent time for processing a respective TB, or a processing chain).

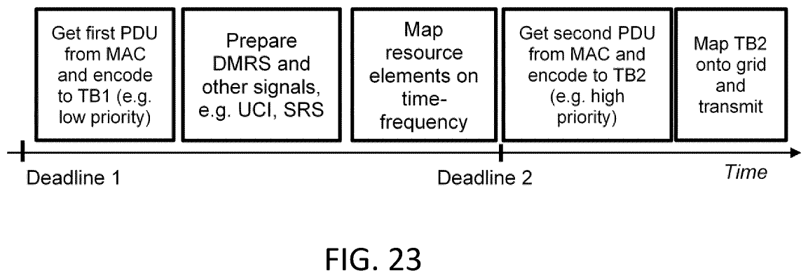

In some embodiments, TBs are processed by different processing chains and, thus, have different timeline requirements. Selection of the processing chain can be preconfigured by RRC (e.g., first TB is always processed by a faster processing chain) or DCI (scheduling command) can provide instructions to WD 22.
If transmission takes place in downlink, WD 22 can prepare HARQ feedback faster (e.g., NR processing capability 2) for one TB compare to another TB.
If transmission is expected in UL, separate timelines for each transport block can be used. For example, for TDM arrangement, the first TB can be encoded with faster processing chain while the second TB starts later, thus, a normal processing speed (or a processing chain that is not as fast as the faster processing chain) may be used. If first TB is of a high priority and can be processed by a faster processing chain, it might mean that wireless device 22 can wait for new data in a buffer a longer time before the start of the TB encoding. This is illustrated in FIG. 23. In other words, processing starting point is different for different TBs, thus, the deadline for TB generation by medium access control (MAC) is also different. FIG. 23 illustrates an example of multiplexing of two transport blocks with separate deadlines/timing requirements.

In one embodiment, the physical downlink shared channel (PDSCH) decoding time for providing HARQ feedback for a TB is determined based on the last OFDM symbol that contains data for the TB. This could enable fast feedback for the TB that ends the soonest.

HARQ-ACK Generation

HARQ-ACK transmission is usually expected if TB multiplexing is triggered in the DL. Since different transport blocks can carry data of different priority, the HARQ feedbacks for them can be transmitted in different codebooks. For example, one physical uplink shared channel (PUSCH) carries two transport blocks, HARQ feedback for TB1 may be added into high priority codebook CB1 while HARQ feedback for TB2 is added in low priority CB2. Such behavior can be configured semi-statically, e.g., first TB feedback may always go to CB1, second TB feedback may always go to CB1, etc. Alternatively, or additionally, in some embodiments, scheduling command (DCI) can contain instructions about CB priority, e.g., priority bit for every TB.

Transmission Arrangement Where a Resource is Configured With Multiple Transmission Options

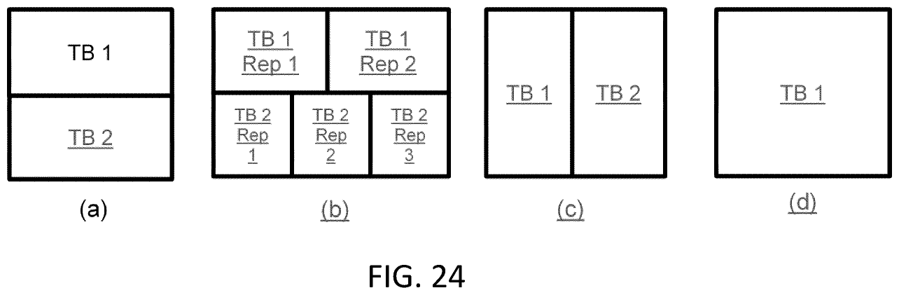

Similar to the embodiments described above, the TB multiplexing alone or with repetitions can be generalized over the time frequency grid. A WD 22 can be configured to receive DL or transmit UL transmission according to multiple options, see examples in FIG. 24. FIG. 24 illustrates an example of the WD 22 being pre-configured with a plurality of options for the transmissions. In some embodiments, the network node may instruct the WD 22 as to which option to follow for every transmission.

In the example shown in FIG. 24, the WD 22 is configured with 4 transmissions options. Depending on the scenario or condition related to the WD 22 or network node 16, the transmission arrangement can be selected from the pre-configured set and a set ID can be signaled in any way defined in any of the signaling aspects discussed above under the heading “signaling aspects” (e.g., RRC, DCI, etc.). In particular, in some embodiments, the following ways of signaling may be considered for e.g., signaling the set ID:
New DCI field can be used, e.g., transmission option ID.
Transmission option may be signaled in other fields (e.g., new column in the TDRA table).

In another embodiment, prioritization or pre-emption, may impact the selection of the transmission option. For example, if prioritization or pre-emption takes place, e.g., as between the TBs in the multiple TBs, transmission option can fallback to a defined transmission option (configured to be default in this case). In some embodiments, this fallback option can be initially selected to ensure e.g., reliability, increase throughput or optimize spectral efficiency in case of collision.

In another embodiment, due to configurations of multiple options, the node (e.g., network node 16 and/or WD 22 depending on DL or UL) can prepare TBs/repetitions for all options in advance. Once the node, receives an indication (from the master node, e.g., or decides autonomously) to go with transmission using a particular option, the node (e.g., network node 16 and/or WD 22 depending on DL or UL) transmits those specific TBs or repetitions (e.g., TB repetitions).

Some embodiments may provide the allocation with multiple options where:
Configuration under each option, the scheduling of TBs can be performed accordingly, such as:
   Each TB within an option is scheduled with a single DCI;
   Multiple TBs within an option with are scheduled with:
      Single DCI; and/or
      Multiple DCIs.
Multiple options altogether scheduled with a single DCI.

In some embodiments, the parameters for different TBs within an option or across the options need not be necessarily same, e.g., they can have same or different MCS, RVs, priorities, SPS/CG/HARQ identifier (ID), etc.

In some embodiments, the transmission (e.g., of the multiple TBs by WD 22 and/or NN 16) based on one of the selected options can be performed based on one or more of:
Explicit indication from the master node, e.g., network node 16 informs via DCI for one of the selected options.
Pre-configured principle or decision-making algorithm working on several inputs, e.g., if the node (network node 16 or WD 22) interested in utilizing one of the options on the resource, and it realizes that the collision or conflict or preemption will happen, such node can switch to another option for the transmission on the same resource. Hence, for this, in some embodiments, the network node 16 or master node can set the priority of the options, e.g., in the example FIG. 24, (d) can be set with a highest priority, then (c), then (a) and then (d) having the lowest priority. In case of transmission on the resource, if the node (network node 16 or WD 22) selects option (d) but found it will be wasted due to collision with some urgent transmission on the portion of resource, then such selects a next relatively lower priority option (c), and so on.
The node (NN 16 or WD 22) autonomously selects one of the options for the transmission on the configured resource. Hence, the receiving node (the other of the WD 22 or NN 16) may perform a robust blind decoding amongst the possible options.

In one embodiment, there may be defined a HARQ ID/process management for this transmission behavior with pre-configured options. More details are described below.

Configuration With One Option Only

As described above, in some embodiments, the node (NN 16 or WD 22) can be configured with multiple options for the transmission. In this solution, a node (NN 16 or WD 22) is configured with only one option. This may allow for simplicity in the solution. As can be seen, the embodiments explained above (related to the FDM or TDM arrangements) is a subset of this embodiment where the WD 22 is configured with options with FDM or TDM arrangements.

Interaction With Inter and Intra WD 22 Prioritization

In one embodiment, if the transmission includes multiple TBs, the transmission, e.g., PUSCH/PDSCH priority is based on a TB with the highest priority amongst the priorities of the multiple TBs. For example, in some embodiments, transmission is of a low priority if all transport blocks are configured/signaled as low priority. In some embodiments, the transmission is of high priority if at least one TB is configured/signaled to be high priority.

In another embodiment, if transmission includes multiple TBs, such transmission always has a high priority.

In another embodiment, if transmission includes multiple TBs, it cannot be cancelled by a cancellation indicator (e.g., DCI scrambled by cancellation indicator RNTI or CI-RNTI).

In another embodiment, if transmission includes multiple TBs, each TB is considered as a separate term in the cancellation process. It means each TB can be cancelled depending on its priority, UL CG or DL SPS index, RRC configuration or based on other DCI fields. For example, if an UL WD 22 is configured with transmission option FIG. 24 (c) only, and conflicts happen with its TB1. The WD 22 transmits TB2, and TB1 may or may not be transmitted depending on the priority of the conflicting transmission (e.g., higher priority should take precedence).

In another embodiment, if a WD 22 has a collision occurring on a portion of its allocated resource, the WD 22 can divide the resources in such a manner onto which multiple TBs can be sent and the low priority TBs map to the colliding portion are dropped. Hence, a WD 22 can effectively utilize all the resource for the transmission, whereas on the colliding portion only the high priority TB is sent.

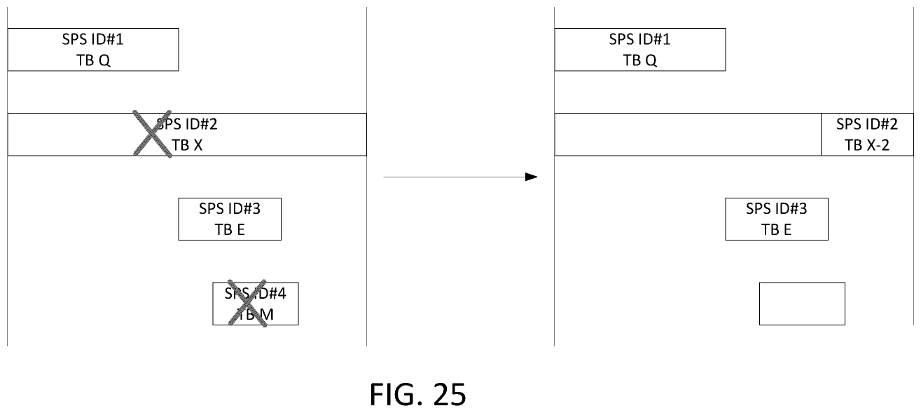

In another embodiment, a WD 22 with multiple allocations in UL (multiple CGs and single/multiple dynamic allocations) or DL (multiple SPSs and single/multiple dynamic allocations) collide, then the WD 22 may use more advanced mechanisms to transmit over such allocation. In one mechanism, where a current rule forces to drop a low priority TB or low priority SPS ID, then in such cases, if there is free allocation due to dropping of such TBs, then over such allocations, some other traffic for the same WD 22 can be accommodated, e.g., see FIG. 25.

FIG. 25 illustrates an example showing where some SPSs' PDSCHs are cancelled (left hand side, due to prioritization). If the WD 22 is provided with multiple options for a given transmission, then network node 16 selects the best suited option and is able to transmit partially (in right hand side), over the resource meant for SPS ID#2 than in the left hand side.

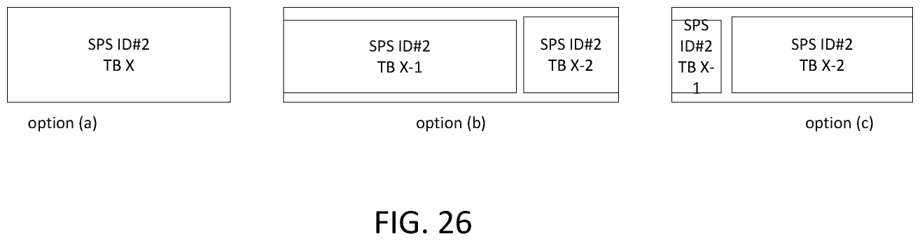

In FIG. 25, the left side depicts collisions amongst a group of SPS allocations (with NR Release 16 understanding), where WD 22 prioritizes transmissions by prioritizing a relative lower SPS ID of the transmission starting with a lowest SPS ID. On right hand side of FIG. 25, as per proposed embodiments, the WD 22 is able to transmit some TBs (e.g., TB X-2) in the conflicting allocations (over the resource meant for SPS ID#2 occasion) by selecting appropriate pre-defined options described and shown in FIG. 26, for example (a given resource configured with multiple options discussed herein).

FIG. 26 illustrates an example of a WD 22 configured with 3 options for TB transmission over SPS#2 occasion. In this occasion, the given HARQ process can be transmitted as a (a) single TB or (b) two TBs or (c) 2 TBs with different fashion with respect to (b).

HARQ Process ID Handling

In some embodiments, if a transmission includes multiple transport blocks (e.g., see FIG. 24), the TBs can belong to one or more of the following:
Same HARQ process, e.g., TB1 and TB2 in all options represent the same HARQ process. This is shown in FIG. 26, where one HARQ process can be allocated via option (a) with full TB, or option (b) with 2 TBs, or option (c) with two TBs with different individual sizes. In FIG. 26, due to collision with SPS ID#1, option (b) is selected for SPS ID#2's HARQ process transmission, where the conflicting TB (TB X-1) for SPS ID#2's HARQ process is not transmitted. Further, these different TBs from the same HARQ process may represent one or more of:
   Repetitions of the same data, e.g., with different RVs (reliability enhancement as the objective); or
   Different data (capacity enhancement as the objective).
Different HARQ process, e.g., TB1 and TB2 in all options represent the two different HARQ processes.
Further extension based on IDs (SPS ID or CG ID), such as:
   Different TBs in the option belong to the same SPS/CG ID. Further, the given SPS/CG ID can be associated with multiple HARQ processes, thus different TBs represent one or more of:
      Same HARQ process for the given SPS/CG ID. Further, these different TBs from the same HARQ process may represent:
         Repetitions of the same data, e.g., with different RVs (reliability enhancement as the objective); or
         Different data (capacity enhancement as the objective);
      Different HARQ processes for the given SPS/CG ID; and/or
   Different TBs in the options belong to different SPS/CG IDs.

Multiplexing of PUCCH/UCI and PUSCH With Multiple TB

In some embodiments, if PUSCH transmission includes multiple TBs, physical uplink control channel/uplink control information (PUCCH/UCI) can be multiplexed in different ways, such as, for example, one or more of:
In one embodiment, UCI is multiplexed (or punctured) with only one TB. Timing rule or RRC configuration determines to which one from the plurality of TBs. For the timing rule, if PUCCH overlaps with only one or subset of TBs, then UCI may be multiplexed with any of those TBs from the subset of TBs.
In another embodiment, UCI of high priority is multiplexed (or punctured) with a high priority TB and UCI of a low priority is multiplexed (or punctured) with a low priority TB.

In another embodiment, different groups of beta factors are used for each TB in e.g., a PUSCH transmission.

Some embodiments of the present disclosure may include one or more of the following:

Embodiment A1. A network node configured to communicate with a wireless device (WD), the network node configured to, and/or comprising a radio interface and/or comprising processing circuitry configured to:
schedule a transmission comprising a plurality of transport blocks (TBs); and
receive and/or transmit the transmission comprising the plurality of TBs based on the scheduling.

Embodiment A2. The network node of Embodiment A1, wherein one or more of:
at least one TB of the plurality of TBs in the scheduled transmission has a different Quality-of-Service (QoS) than at least one other TB;
the scheduling of the transmission comprising the plurality of TBs is in a single downlink control information (DCI) message;
the scheduling of the transmission comprising the plurality of TBs is in a single radio resource control (RRC) message;
the transmission is a single transmission partitioned to include the plurality of TBs; and/or
one set of demodulation reference signal (DMRS) is used for the transmission.

Embodiment B1. A method implemented in a network node, the method comprising:
scheduling a transmission comprising a plurality of transport blocks (TBs); and
receiving and/or transmitting the transmission comprising the plurality of TBs based on the scheduling.

Embodiment B2. The method of Embodiment B1, wherein one or more of:
at least one TB of the plurality of TBs in the scheduled transmission has a different Quality-of-Service (QoS) than at least one other TB;
the scheduling of the transmission comprising the plurality of TBs is in a single downlink control information (DCI) message;
the scheduling of the transmission comprising the plurality of TBs is in a single radio resource control (RRC) message;
the transmission is a single transmission partitioned to include the plurality of TBs; and/or
one set of demodulation reference signal (DMRS) is used for the transmission.

Embodiment C1. A wireless device (WD) configured to communicate with a network node, the WD configured to, and/or comprising a radio interface and/or processing circuitry configured to:
receive signaling, the signaling scheduling a transmission comprising a plurality of transport blocks (TBs); and
receive and/or transmit the transmission comprising the plurality of TBs based on the scheduling.

Embodiment C2. The WD of Embodiment C1, wherein one or more of:
at least one TB of the plurality of TBs in the scheduled transmission has a different Quality-of-Service (QoS) than at least one other TB;
the scheduling of the transmission comprising the plurality of TBs is in a single downlink control information (DCI) message;
the scheduling of the transmission comprising the plurality of TBs is in a single radio resource control (RRC) message;
the transmission is a single transmission partitioned to include the plurality of TBs; and/or
one set of demodulation reference signal (DMRS) is used for the transmission.

Embodiment D1. A method implemented in a wireless device (WD), the method comprising:
receiving signaling scheduling a transmission comprising a plurality of transport blocks (TBs); and
receiving and/or transmitting the transmission comprising the plurality of TBs based on the scheduling.

Embodiment D2. The method of Embodiment D1, wherein one or more of:
at least one TB of the plurality of TBs in the scheduled transmission has a different Quality-of-Service (QoS) than at least one other TB;
the scheduling of the transmission comprising the plurality of TBs is in a single downlink control information (DCI) message;
the scheduling of the transmission comprising the plurality of TBs is in a single radio resource control (RRC) message;
the transmission is a single transmission partitioned to include the plurality of TBs; and/or
one set of demodulation reference signal (DMRS) is used for the transmission.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a network node configured to communicate with a wireless device, WD, the method comprising:
scheduling using a single downlink control information, DCI, message a first transmission with repetition of a first transport block, TB, and a second transmission with repetition of a second TB, the repetitions of the first and second TBs being mapped to non-overlapping time-domain resources and the repetitions of first and second TB s being mapped to a same physical resource block, PRB, set; and
triggering the first transmission with repetition of the first TB and the second transmission with repetition of the second TB based on the single DCI scheduling.

2. (canceled)

3. The method of claim 1, wherein the first transmission with repetition comprises a mini-slot repetition of the first TB and the second transmission with repetition comprises a mini-slot repetition of the second TB.

4. (canceled)

5. The method of claim 1, wherein the first transmission with repetition comprises a mini-slot repetition of the first TB and the second transmission with repetition comprises a slot-based repetition of the second TB.

6. (canceled)

7. (canceled)

8. The method of claim 1, wherein the first transmission comprises a first number of repetitions of the first TB and the second transmission comprises a second number of repetitions of the second TB, the first number being different than the second number.

9-12. (canceled)

13. The method of claim 1, further comprising skipping a repetition of at least one of the first and second TB.

14. A method implemented in a wireless device, WD, configured to communicate with a network node, the method comprising:
receiving a single downlink control information, DCI, message scheduling a first transmission with repetition of a first transport block, TB, and a second transmission with repetition of a second TB, the repetitions of the first and second TBs being mapped to non-overlapping time-domain resources and the repetitions of first and second TB s being mapped to a same physical resource block, PRB, set; and
processing the repetitions of the first TB and the repetitions of the second TB based at least in part on the single DCI scheduling.

15. (canceled)

16. The method of claim 14, wherein the first transmission with repetition comprises a mini-slot repetition of the first TB and the second transmission with repetition comprises a mini-slot repetition of the second TB.

17. (canceled)

18. The method of claim 14, wherein the first transmission with repetition comprises a mini-slot repetition of the first TB and the second transmission with repetition comprises a slot-based repetition of the second TB.

19. (canceled)

20. (canceled)

21. The method of claim 14, wherein the first transmission comprises a first number of repetitions of the first TB and the second transmission comprises a second number of repetitions of the second TB, the first number being different than the second number.

22-25. (canceled)

26. The method of claim 14, further comprising skipping a repetition of at least one of the first and second TB.

27. A method implemented in a network node configured to communicate with a wireless device, WD, the method comprising:
scheduling using a single downlink control information, DCI, message a first transmission of a first transport block, TB, and a second transmission of a second TB, the first TB being mapped to a first subset of a physical resource block, PRB, set and the second TB being mapped to a second subset of the PRB set, the first subset corresponding to different frequency resources than the second subset; and
triggering the first transmission of the first TB and the second transmission of the second TB based on the single DCI scheduling.

28. (canceled)

29. (canceled)

30. The method of claim 27, wherein the first and second TBs are mapped to overlapping time-domain resources.

31. The method of claim 27, wherein the first transmission is with repetition of the first TB and the second transmission is with repetition of the second TB.

32. The method of claim 27, wherein the first transmission is without repetition of the first TB and the second transmission is with repetition of the second TB.

33. The method of claim 27, wherein at least one of:
a first number of PRBs corresponding to the first transmission of the first TB is different from a second number of PRBs corresponding to the second transmission of the second TB; and
a first number of orthogonal frequency division multiplexing, OFDM, symbols corresponding to the first transmission of the first TB is different from a second number of OFDM symbols corresponding to the second transmission of the second TB.

34-36. (canceled)

37. A method implemented in a wireless device, WD, configured to communicate with a network node, the method comprising:
receiving a single downlink control information, DCI, message scheduling a first transmission of a first transport block, TB, and a second transmission of a second TB, the first TB being mapped to a first subset of a physical resource block, PRB, set and the second TB being mapped to a second subset of the PRB set, the first subset corresponding to different frequency resources than the second subset; and
processing the first transmission of the first TB and the second transmission of the second TB based on the single DCI scheduling.

38. (canceled)

39. (canceled)

40. The method of claim 37, wherein the first and second TBs are mapped to overlapping time-domain resources.

41. The method of claim 37, wherein the first transmission is with repetition of the first TB and the second transmission is with repetition of the second TB.

42. The method of claim 37, wherein the first transmission is without repetition of the first TB and the second transmission is with repetition of the second TB.

43. The method of claim 37, wherein at least one of:
a first number of PRBs corresponding to the first transmission of the first TB is different from a second number of PRBs corresponding to the second transmission of the second TB; and
a first number of orthogonal frequency division multiplexing, OFDM, symbols corresponding to the first transmission of the first TB is different from a second number of OFDM symbols corresponding to the second transmission of the second TB.

44-48. (canceled)
